(19) United States
(12) Patent Application Publication
(10) Pub. No.: US 2025/0332789 A1
(43) Pub. Date: Oct. 30, 2025

(54) ADDITIVE MANUFACTURING DEVICE AND PREPARATION METHOD

(71) Applicant: TRUMPF Laser- und Systemtechnik SE, Ditzingen (DE)

(72) Inventors: Dominik MAURER, Stuttgart (DE); Fatih ARIKCAN, Untergruppenbach (DE)

(21) Appl. No.: 19/260,635

(22) Filed: Jul. 7, 2025

Related U.S. Application Data
(63) Continuation of application No. PCT/EP2023/085777, filed on Dec. 14, 2023.

(30) Foreign Application Priority Data
Jan. 10, 2023 (DE) 10 2023 100 365.8

(51) Int. Cl. B29C 64/176; B22F 10/28; B22F 12/30; B22F 12/50; B29C 64/153; B29C 64/255; B29C 64/321; B33Y 10/00; B33Y 30/00

(52) U.S. Cl. CPC B29C 64/176; B22F 10/28; B22F 12/30; B22F 12/50; B29C 64/153; B29C 64/255; B29C 64/321; B33Y 10/00; B33Y 30/00

(57) ABSTRACT

An additive manufacturing device, for series manufacturing of at least two manufacturing orders using a manufacturing cylinder of the additive manufacturing device, includes at least one powder compartment that is movably arranged within a process chamber of the additive manufacturing device. The additive manufacturing device is configured to move the at least one powder compartment within the process chamber. The at least one powder compartment is configured to at least partially receive a process powder column formed from a process powder in the manufacturing cylinder. The additive manufacturing device is configured to move the at least one powder compartment and the process powder column accommodated in the at least one powder compartment.

### CROSS REFERENCE TO RELATED APPLICATIONS

This application is a continuation of International Application No. PCT/EP2023/085777 (WO 2024/149560 A1), filed on Dec. 14, 2023, and claims benefit to German Patent Application No. DE 10 2023 100 365.8, filed on Jan. 10, 2023. The aforementioned applications are hereby incorporated by reference herein.

### FIELD

The invention relates to an additive manufacturing device for series manufacturing of at least two manufacturing orders. The invention also relates to a preparation method for preparing an additive manufacturing device.

### BACKGROUND

Conventional additive manufacturing devices have one or more manufacturing cylinders. The manufacturing cylinders are used to manufacture manufacturing orders using the additive manufacturing device, wherein one single manufacturing order or several manufacturing orders can be manufactured simultaneously per manufacturing cylinder. With powder bed laser fusion (PBLF) in particular, the production of individual or multiple manufacturing orders in a manufacturing cylinder depends on the size of the manufacturing cylinder and the manufacturing order to be produced. During manufacturing, a manufacturing plate in the manufacturing cylinder is typically lowered in stages and the resulting process trough is filled with process powder. The filled process powder is then formed layer by layer into a manufacturing order through partial solidification, e.g., fusing. The manufacturing order formed by solidified process powder is surrounded by loose or unsolidified process powder in the manufacturing cylinder.

Once the manufacturing order has been completed, the manufacturing cylinder is occupied by the manufacturing orders manufactured therein, which prevents the subsequent production of further manufacturing orders in the manufacturing cylinder. The completed manufacturing orders are usually manually removed from the additive manufacturing device by an operator, which results in operation-related downtimes of the additive manufacturing device. This reduces the degree of automation of the additive manufacturing device.

In addition, the manufacturing cylinder must be moved, typically lifted, to a starting position in order to remove the manufacturing order. However, when the manufacturing cylinder is lifted, unsolidified or loose process powder enters the process chamber next to the manufacturing cylinder. This process powder must then be laboriously removed before a new manufacturing order can be started in the additive manufacturing device. In particularly drastic cases, process powder gets into the openings of the gas supply unit when the manufacturing cylinder is lifted, blocking them. This can considerably impair the manufacturing order of the subsequent manufacturing order, even after thoroughly cleaned.

If the manufacturing order is removed by an operator or if process powder needs to be removed, the additive manufacturing device must be opened. As a result, the protective gas atmosphere formed in the additive manufacturing device is also destroyed and must then be renewed by “inerting” the additive manufacturing device before starting another manufacturing order.

DE 10 2019 204 781 A1 discloses an additive manufacturing device in which a manufactured component together with a substrate plate is transferred to a magazine or an adjacent collection chamber by a coater of the manufacturing device.

WO 2016 030 530 A1 discloses a method and a device for unpacking a component, in which a manufactured component is separated from unsolidified particle material outside a construction box by means of an auxiliary frame.

### SUMMARY

In an embodiment, the present disclosure provides an additive manufacturing device for series manufacturing of at least two manufacturing orders using a manufacturing cylinder of the additive manufacturing device, including at least one powder compartment that is movably arranged within a process chamber of the additive manufacturing device. The additive manufacturing device is configured to move the at least one powder compartment within the process chamber. The at least one powder compartment is configured to at least partially receive a process powder column formed from a process powder in the manufacturing cylinder. The additive manufacturing device is configured to move the at least one powder compartment and the process powder column accommodated in the at least one powder compartment.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a preparation method according to an embodiment of the invention in a schematic representation;

FIG. 2 shows a schematic representation of an additive manufacturing device according to an embodiment of the invention with a powder compartment arranged in a holding position;

FIG. 3 shows a schematic representation of the additive manufacturing device from FIG. 2 with the powder compartment arranged in a receiving position;

FIG. 4 shows a schematic representation of the additive manufacturing device shown in FIGS. 2 and 3 with the powder compartment and a process powder column accommodated therein as well as a manufacturing plate;

FIG. 5 shows a schematic representation of the additive manufacturing device shown in FIGS. 2 to 4 with the powder compartment having the process powder column in the holding position;

FIG. 6 shows an embodiment of an additive manufacturing device in a detailed view of a decoupling ramp, a manufacturing cylinder, a coater unit, and a powder compartment;

FIG. 7 shows the additive manufacturing device from FIG. 6 in a detailed view of the coater unit arranged in a pulling manner on the powder compartment;

FIG. 8 shows the additive manufacturing device from FIG. 6 in a detailed view of the coater unit arranged in a pushing manner on the powder compartment;

FIG. 9 shows the additive manufacturing device from FIG. 6 in a detailed view of the powder compartment arranged on the decoupling ramp in a sectioned plan view;

FIG. 10 shows a side view of the powder compartment from FIG. 9 arranged on the decoupling ramp; and

FIG. 11 shows the powder compartment from FIGS. 6 to 10 in a view of an end-face compartment section.

### DETAILED DESCRIPTION

Embodiments of the invention provide a device with which automatic and series manufacturing of manufacturing orders can be carried out without opening the additive manufacturing device. Embodiments of the invention also provide a preparation method for preparing an additive manufacturing device.

An additive manufacturing device is provided according to an embodiment of the invention. The additive manufacturing device is, in a preferred embodiment, configured to carry out powder bed laser fusion (PBLF). Furthermore, the additive manufacturing device is designed for the series or successive manufacturing of at least two manufacturing orders by means of a single manufacturing cylinder of the additive manufacturing device.

Above and below, series manufacturing is defined as the manufacturing of several manufacturing orders, whereby the additive manufacturing device begins manufacturing with each manufacturing order from a starting position. For example, the starting position of an additive manufacturing device configured for powder bed-based laser beam fusion means the initial lowering of a manufacturing plate of the manufacturing cylinder relative to a working plane of the additive manufacturing device.

Furthermore, the additive manufacturing device has at least one powder compartment. The powder compartment is movably arranged within the process chamber. In other words, the powder compartment can be moved within the process chamber. According to an embodiment of the invention, the additive manufacturing device is designed for moving the powder compartment within the process chamber. The powder compartment can, for example, have a drive unit that is controlled by the additive manufacturing device, in particular a control unit of the additive manufacturing device.

According to an embodiment of the invention, the powder compartment is designed for at least partially receiving a process powder column formed from a process powder in the manufacturing cylinder. In a preferred embodiment, the powder compartment is designed to completely accommodate the process powder column. Above and below, a process powder column is defined as an arrangement of loose and solidified process powder that is formed within the manufacturing cylinder during the manufacturing of the manufacturing order.

The powder compartment, in a preferred embodiment, has a compartment wall that delimits a receiving area of the powder compartment from the process chamber of the additive manufacturing device. In other words, the powder compartment forms a powder barrier, whereby the process powder accommodated in the powder compartment can be kept inside the powder compartment. The compartment wall can be formed at least in sections in the circumferential direction. In a preferred embodiment, the compartment wall is predominantly circumferential in the circumferential direction. As an alternative to the one or more compartment walls of the powder compartment, one or more flaps or retractable walls can be provided, which are positioned in front of the shielding gas inlets/outlets and can be retracted/extended. Alternatively, a surround can be provided, for example in the form of a cylinder, which is either extended when the manufacturing plate is extended and thus surrounds the process powder on the manufacturing plate, or a surround can be printed during manufacturing so that the manufacturing order and the process powder are surrounded by a printed surround. An alternative powder extraction system can also be used as an alternative to the compartment wall. For example, a suction cup can be inserted from above or a type of vacuum cleaner device can be used.

The additive manufacturing device can have at least one side compartment section. In a preferred embodiment, the additive manufacturing device has at least two lateral compartment sections. The compartment sections can be arch-shaped. In a preferred embodiment, the lateral compartment sections are formed parallel to the compartment displacement axis. Lateral compartment sections support the process powder column accommodated in the powder compartment transversely to the compartment displacement axis, whereby lateral trickling and/or slipping of the process powder during accommodation of the process powder column and/or displacement of the powder compartment can be prevented.

Alternatively or additionally, the powder compartment can have at least one end-face compartment section. The end-face compartment section is, in a preferred embodiment, formed predominantly at an angle or perpendicular to the compartment displacement axis. An end-face compartment section supports the process powder column along the compartment displacement axis and prevents process powder from trickling and/or slipping off along the compartment displacement axis during accommodation of the process powder column and/or displacement of the powder compartment.

The additive manufacturing device is designed for displacing the powder compartment and the process powder column accommodated in the powder compartment. Typically, the powder compartment is movable along a predetermined compartment path within the additive manufacturing device. In a preferred embodiment, the compartment path is formed in a straight line along a compartment displacement axis of the powder compartment. This favors a short displacement distance and rapid movement of the powder compartment. Alternatively, the powder compartment can be fitted from above or inserted from below through corresponding openings.

Embodiments of the present invention relate to an additive manufacturing device having a powder compartment which is formed for accommodating the process powder arranged in the manufacturing cylinder. By accommodating the process powder in the powder compartment, the process powder can be removed from the manufacturing cylinder without the process powder entering the process chamber or openings in the gas supply of the additive manufacturing device next to the manufacturing cylinder. This means that there is no need to clean the additive manufacturing device in preparation for another manufacturing order, thereby increasing the degree of automation. Furthermore, the additive manufacturing device can be prepared in a closed state, which maintains the protective gas atmosphere in the process chamber.

In a preferred embodiment of the additive manufacturing device, this has a coater unit for filling or coating the manufacturing cylinder with the process powder. Filling or coating is typically performed by moving the coater unit along a coater movement axis. According to the embodiment, the powder compartment is designed for moving along the coater movement axis. In a preferred embodiment, the powder compartment is designed for moving through the coater unit along the coater movement axis. This eliminates the need for a separate drive unit on the powder compartment. Alternatively, such a separate drive unit can be provided, for example on a wall of the process chamber, which is designed to move the powder compartment. For example, a rod could be provided which is firmly connected to the powder compartment. Alternatively, one or more slide valves can be provided which push the powder compartment over the base of the process chamber. This means that the drive of the coater unit can be smaller, as it only needs to be designed to push process powder.

In a preferred further development of the additive manufacturing device, the coater unit is designed for pushing the powder compartment. In a preferred embodiment, the coater unit is designed to push the powder compartment from a receiving position above the manufacturing cylinder into a holding position next to the manufacturing cylinder. In other words, the coater unit is arranged downstream of the powder compartment in a direction of movement of the powder compartment from the receiving position to the holding position.

In a particularly preferred embodiment of the additive manufacturing device, the coater unit forms a section of the compartment wall. In a preferred embodiment, the coater unit forms an end-face compartment section. The coater unit, in a preferred embodiment, forms a compartment section downstream in the direction of movement. This means that the amount of material used to form the powder compartment can be kept to a minimum.

A further development of the additive manufacturing device is also preferred, in which the coater unit is designed to pull the powder compartment. In a preferred embodiment, the coater unit is designed to pull the powder compartment from a holding position next to the manufacturing cylinder to a receiving position above the manufacturing cylinder. The powder compartment and/or the coater unit can have coupling means for this purpose.

In a preferred embodiment of the additive manufacturing device in conjunction with a coater unit described above and below, the powder compartment is designed for temporary or detachable arrangement on the coater unit. In other words, the powder compartment can be connected to the coater unit. For example, it can be provided that the coater unit is coupled to the powder compartment by means of an electromagnet.

In a preferred embodiment, the powder compartment is designed for mechanical arrangement on the coater unit. In a particularly preferred embodiment, the powder compartment and/or the coater unit has at least one pulling hook which engages in a complementary retaining structure of the powder compartment or the coater unit for pulling movement by the coater unit. The pulling hook is, in a particularly preferred embodiment, arranged or formed on the coater unit and engages behind the compartment wall of the powder compartment through a pulling recess formed on the compartment wall. This allows the coater unit to be coupled to the powder compartment using technically simple means.

An embodiment of the additive manufacturing device is further preferred, in which the powder compartment is designed for receiving a manufacturing plate carrying the process powder column. In other words, the process powder column can be accommodated in the powder compartment together with the manufacturing plate supporting the process powder column. This allows the process powder column to be supported particularly securely. The additive manufacturing device is typically designed for displacing the powder compartment together with the manufacturing plate accommodated in the powder compartment.

In a preferred further development of the additive manufacturing device, this comprises a spacer. The spacer is designed for arrangement on the manufacturing plate in order to create a minimum distance between the process powder compartment and the process powder column. In a preferred embodiment, the spacer is arranged on the coater unit.

In a particular embodiment, the additive manufacturing device has a decoupling ramp. The decoupling ramp is, in a preferred embodiment, arranged or formed in the holding position of the additive manufacturing device. Typically, the powder compartment is moved, in a particular embodiment pushed, onto the decoupling ramp by the coater unit, wherein the powder compartment is raised relative to the coater unit. This makes it possible to couple the powder compartment and the coater unit by simple and technically robust means, for example in the case of pulling hooks engaging behind the compartment wall.

In a particularly preferred embodiment, the decoupling ramp is designed to lift the powder compartment faster and/or higher than a manufacturing plate. For this purpose, the decoupling ramp can have at least one plate ramp, in a particular embodiment several plate ramps, for guiding the manufacturing plate and at least one compartment ramp, in particular several compartment ramps, for guiding an end-face compartment section of the powder compartment. The plate ramp(s) can be arranged centrally between the compartment ramps. The plate ramp(s) can be flatter and/or lower than the compartment ramp(s). The top of the compartment ramp(s) can have a recess, in a particular embodiment a groove, for horizontally locking the end-face compartment section.

Embodiments of the invention also provide a preparation method.

The preparation method is, in a preferred embodiment, configured for preparing the additive manufacturing device described above and below. In other words, the preparation method is configured to enable the series manufacturing of at least two manufacturing orders in the additive manufacturing device. The preparation method is thus designed for preparing the additive manufacturing device while maintaining a protective gas atmosphere in the process chamber of the additive manufacturing device. The preparation method can be carried out on the closed additive manufacturing device.

The additive manufacturing device has at least one manufacturing cylinder described above and below and at least one powder compartment described above and below.

An embodiment of the invention provides a preparation method that has the following method steps: one method step involves the production of a first manufacturing order in the manufacturing cylinder. Typically, the manufacturing order is manufactured by filling the manufacturing cylinder with process powder in layers and partially solidifying the process powder. The manufacturing order can be manufactured using powder bed-based laser fusion, for example.

A further method step involves moving the powder compartment from a holding position to a receiving position above the manufacturing cylinder. The holding position is, in a preferred embodiment, at such a distance from the manufacturing cylinder that the powder compartment in the holding position does not hinder the manufacturing of the manufacturing order.

In a preferred embodiment, the powder compartment remains in the holding position during the manufacturing of the first manufacturing order, which means that any obstruction of the manufacturing process scan be avoided even more reliably.

In a preferred embodiment, the holding position and the receiving position are in the same plane, in particular in the working plane of the additive manufacturing device. This makes it particularly easy to move the powder compartment.

A further method step involves accommodating the process powder column of the manufacturing cylinder in the powder compartment. The process powder column is, in a preferred embodiment, moved into the powder compartment by lifting the manufacturing plate of the manufacturing cylinder in a vertical direction.

Advantageously, several manufacturing plates are arranged in the manufacturing cylinder so that after the manufacturing plate above, on which a manufacturing order has been produced, has been removed, another manufacturing order can be produced directly afterwards on the manufacturing plate below. In a preferred embodiment, the manufacturing cylinders stacked on top of each other in the manufacturing cylinder are centered, preferably with the aid of seals attached to the outside of the manufacturing cylinders.

In a preferred embodiment, seals and/or sliding feet can be provided on the underside of the manufacturing plates, which make it easier for them to slide across the floor of the process chamber when removing them, thereby also preventing scratches on the floor.

The preparation method also has a method step in which the powder compartment is moved from the receiving position to the holding position. In a preferred embodiment, the powder compartment is moved along the working plane into the holding position. A second manufacturing order can then be manufactured in the manufacturing cylinder.

In a preferred embodiment of the preparation method, the additive manufacturing device has the coater unit described above and below for filling the manufacturing cylinder with process powder. In this case, the preparation method can provide for the powder compartment to be moved from the receiving position to the holding position by the coater unit. In a particular embodiment, the powder compartment is pushed into the holding position by the coater unit.

In a preferred embodiment, several holding positions can be provided in the process chamber so that several finished manufacturing orders can be placed in the process chamber. This makes it possible to produce several manufacturing orders or build jobs without opening the process chamber, so that the process chamber does not need to be inerted again.

An embodiment of the preparation method is also preferred, in which the powder compartment is coupled to the coater unit and moved from the holding position to the receiving position by the coater unit. In a particular embodiment, the powder compartment is pulled into the receiving position by the coater unit.

In a preferred embodiment, a measuring system can be provided which records and/or monitors, e.g., with a QR code by means of camera monitoring, the position of the powder compartment for the respective method step. This ensures that the preparation method has been carried out and a new manufacturing order can be started.

Furthermore, an airlock can be provided on the process chamber, which has a transfer chamber and is used to push manufacturing plates with manufacturing orders or components already manufactured on them from the process chamber into the transfer chamber. This can be done with the coater as well as with a slide valve or similar. Advantageously, the transfer chamber has an interface in the form of a wall, door or airlock that can be opened and closed. In a preferred embodiment, the transfer chamber is kept inert, in particular when the interface to the process chamber is opened. The interface to the process chamber is closed in order to remove the manufacturing plates with manufacturing orders located in the transfer chamber. The transfer chamber advantageously has a further wall, door or airlock, which is used to remove the manufacturing plates with manufacturing orders.

Further features and advantages of the embodiments of the invention can be found in the description, the claims, and the drawing. According to embodiments of the invention, the features mentioned above and those yet to be explained further can be used in each case individually or together in any desired expedient combinations. The embodiments shown and described should not be understood as an exhaustive list, but rather are of an exemplary character for describing the embodiments of the invention.

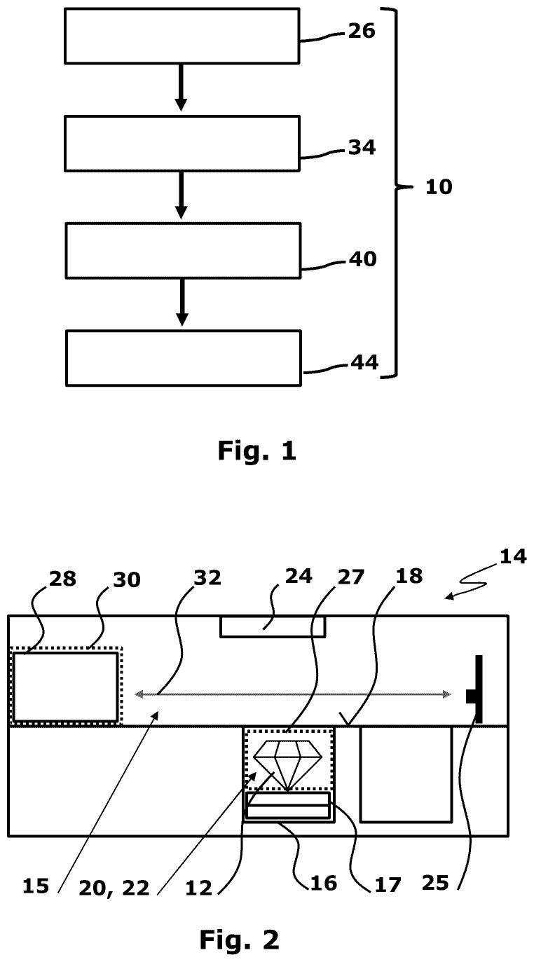

FIG. 1 shows a schematic representation of a preparation method 10 according to an embodiment of the invention. The preparation method 10 is explained below with reference to FIGS. 2 to 5.

The preparation method 10 according to an embodiment of the invention is designed for series or consecutive manufacturing of two manufacturing orders 12 in an additive manufacturing device 14. In other words, an additive manufacturing device 14 can be prepared by the proposed preparation method 10 in such a way that, in addition to a first manufacturing order 12, a further manufacturing order 12 can be manufactured in the same additive manufacturing device 14. The manufacturing orders 12 are preferably manufactured while maintaining a protective gas atmosphere in a process chamber 15 of the additive manufacturing device 14. In other words, according to the preparation method 10, two manufacturing orders 12 can be manufactured with the same additive manufacturing device 14 without having to renew the protective gas atmosphere inside the process chamber 15. This is typically the case when the additive manufacturing device 14 is opened to remove a finished manufacturing order 12. In addition, the degree of automation of the additive manufacturing device 14 can be increased with the preparation method 10, since a second manufacturing order 12 can be started without the intervention of an operator (not shown). For example, downtimes of the additive manufacturing device 14 outside of the operator's working hours can be avoided.

The additive manufacturing device 14 has at least one manufacturing cylinder 16 in the process chamber 15. The manufacturing cylinder 16 is usually used to manufacture the manufacturing order 12.

Powder bed laser fusion (PBLF), for example, is a typical manufacturing process for manufacturing a manufacturing order 12. Here, a manufacturing plate 17 of the manufacturing cylinder 16 is lowered in stages from a working plane 18 of the additive manufacturing device 14 to manufacture a manufacturing order 12 within the manufacturing cylinder 16. In the present embodiment, the manufacturing plate 17 has a round manufacturing area or manufacturing surface. However, the manufacturing plate 17 can also have an angular shape or any other shape, e.g., square, preferably with rounded edges. Each time the manufacturing plate 17 is lowered, a powder trough 20 is formed between the manufacturing plate 17 and the working plane 18, which is filled with process powder 22. The filled process powder 22 can then be partially solidified by a laser beam of a laser beam unit 24, so that a production layer (not shown) of the manufacturing order 12 is formed. The manufacturing plate 17 is then lowered again and the production steps described above are carried out again until the manufacturing plate 17 is completely lowered and/or the manufacturing order 12 is completed. The powder trough 20 can be filled, for example, by a coater unit 25 of the additive manufacturing device 14, which is movably arranged on the working plane 18.

According to a method step 26 of the preparation method 10 according to an embodiment of the invention, a first manufacturing order 12 is manufactured in the manufacturing cylinder 16, for example by the powder bed-based laser beam fusion described above. In the manufacturing cylinder 16, a process powder column 27 consisting of loose and solidified process powder 22 is formed in layers. Typically, the solidified process powder 22 represents the manufacturing order 12, which is surrounded by loose process powder 22.

The additive manufacturing device 14 also has a powder compartment 28. The powder compartment 28 is arranged in a holding position 30 within the additive manufacturing device 14. The holding position 30 is preferably provided on the working plane 18 of the additive manufacturing device 14. Typically, the holding position 30 is configured at a distance from the manufacturing cylinder 16 in order to prevent the powder compartment 28 from interfering with the manufacturing process. In other words, the powder compartment 28 remains in the holding position 30 during the manufacturing of the manufacturing order 12.

The powder compartment 28 is movably arranged within the additive manufacturing device 14 or the process chamber 15. Preferably, the powder compartment 28 is designed to move along a direction of movement 32 on the working plane 18. After completion of the manufacturing order 12, as shown, it may be provided that a movable unit arranged within the additive manufacturing device 14, here the coater unit 25, is moved in the direction of the powder compartment 28 and coupled to the powder compartment 28 in order to move the powder compartment 28 within the additive manufacturing device 14. The movable unit or the coater unit 25 and the powder compartment 28 are preferably designed to be coupled temporarily for this purpose. Alternatively, it may be provided that the powder compartment 28 has its own drive unit (not shown), which enables movement within the process chamber 15 independently of the coater unit 25.

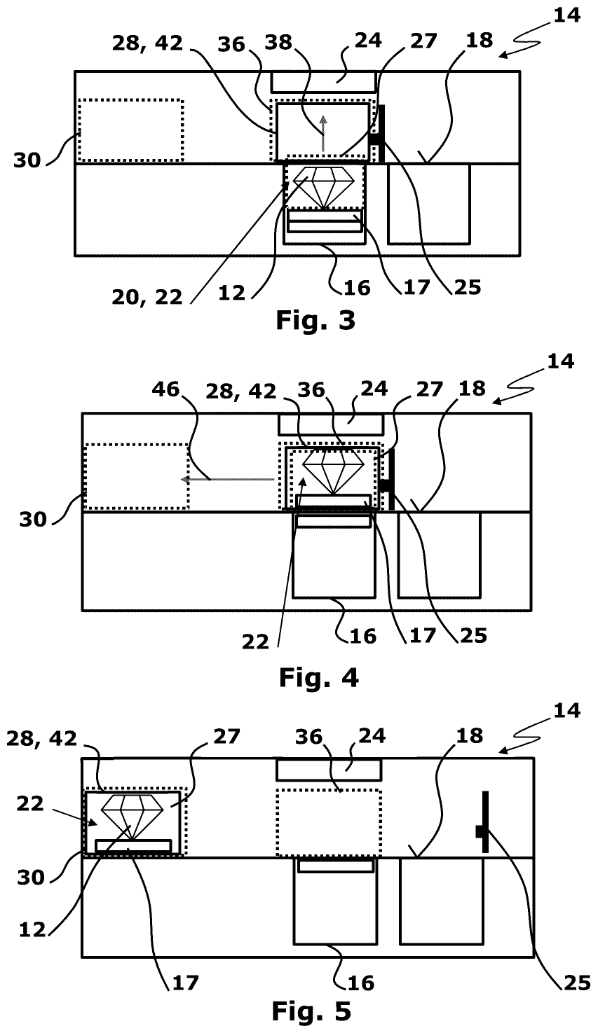

As shown in FIG. 3, in a further method step 34 of the preparation method 10 according to an embodiment of the invention, the powder compartment 28 is moved from the holding position 30 to a receiving position 36 above the manufacturing cylinder 16. Preferably, the powder compartment 28 is moved on the working plane 18. As shown, the powder compartment 28 is pulled into the receiving position 36 by the coater unit 25. The receiving position 36 is located in the vertical direction 38 above the manufacturing cylinder 16. In other words, the powder compartment 28 arranged in the receiving position 36 extends the manufacturing cylinder 16 in the vertical direction 38, at least in sections.

In a further method step 40 of the preparation method 10, the powder compartment 28 accommodates the process powder column 27 formed in the manufacturing cylinder 16. Preferably, the powder compartment 28 completely accommodates the process powder column 27. As shown in FIG. 3, the manufacturing plate 17 is raised in the vertical direction for this purpose, whereby the process powder column 27 is moved from a position below the working plane 18 to a position above the working plane 18. In a particular embodiment of the preparation method 10, as shown, the manufacturing plate 17 is also moved from a position below the working plane 18 to a position above the working plane 18. In other words, according to this embodiment, the powder compartment 28 accommodates the process powder column 27 and the manufacturing plate 17.

FIG. 4 shows the additive manufacturing device 14 in a state in which the process powder column 27 and the manufacturing plate 17 are arranged inside the powder compartment 28. In other words, the powder compartment 28 forms a compartment wall 42 above the manufacturing cylinder 16, which limits slipping or trickling of loose process powder 22 contained in the process powder column 27 depending on the direction. The powder compartment 28 ensures that loose process powder 22 from the process powder column 27 cannot enter manufacturing-relevant areas of the additive manufacturing device 14, in particular gas supply openings.

In a further method step 44 of the preparation method 10, the powder compartment 28 is moved from the receiving position 36 to the holding position 30, as shown in FIG. 4. In particular, the process powder column 27 accommodated in the powder compartment 28 and, if applicable, the manufacturing plate 17 are radially spaced from the manufacturing cylinder 16 on the working plane 18 in the direction of movement 46. As shown, the powder compartment 28 is pushed into the holding position 30 by the coater unit 25. The powder compartment 28 also prevents process powder 22 from entering the manufacturing-relevant areas of the additive manufacturing device 14. This eliminates the need for subsequent time-consuming cleaning of the manufacturing-relevant areas of the additive manufacturing device 14, which reduces downtime and increases the degree of automation of the additive manufacturing device 14.

FIG. 5 shows the additive manufacturing device 14 in a state in which the powder compartment 28 with the process powder column 27 accommodated therein and the manufacturing plate 17 are in the holding position 30. The compartment wall 42 prevents trickling and/or falling of the process powder 22.

As shown, the coater unit 25 is decoupled from the powder compartment 28 and is in a waiting position. The additive manufacturing device 14 is prepared for producing a further manufacturing order 12 in the manufacturing cylinder 16.

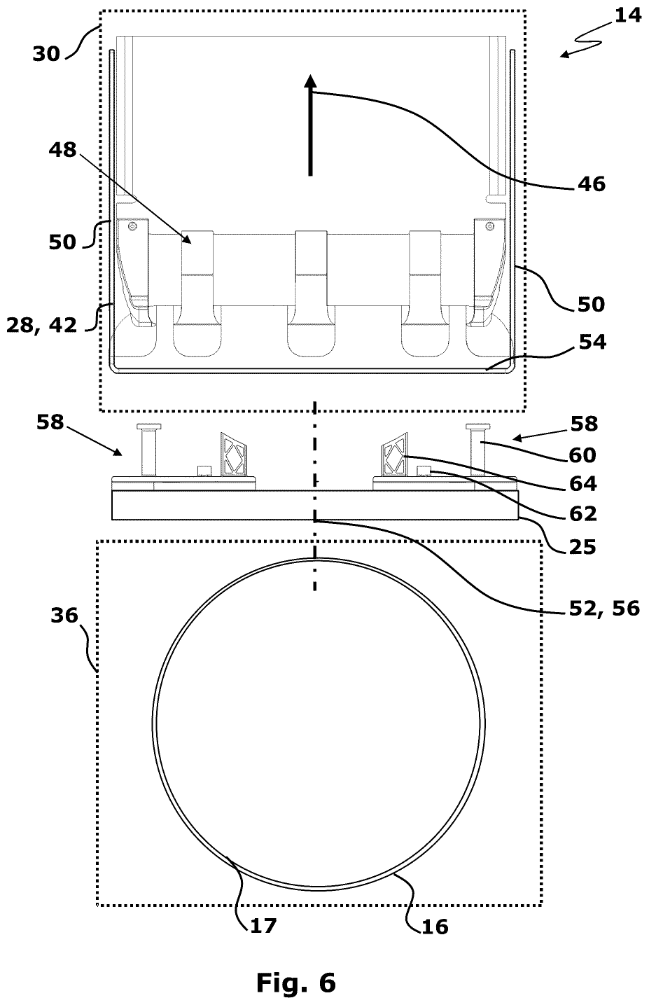

FIG. 6 shows an embodiment of the additive manufacturing device 14 in a detailed view of the manufacturing cylinder 16 of the additive manufacturing device 14. For reasons of clarity, only the manufacturing cylinder 16, the manufacturing plate 17, the coater unit 25, the powder compartment 28 and a decoupling ramp 48 are shown.

According to the embodiment shown, the powder compartment 28 is U-shaped and has a compartment wall 42. The compartment wall 42 prevents process powder 22 from trickling and/or falling out in three directions. The powder compartment 28 here has two lateral compartment sections 50, which are formed parallel to a compartment displacement axis 52. The lateral compartment sections 50 are formed transversely to the compartment displacement axis 52 to support the process powder column 27 (see FIGS. 2 to 5) and prevent lateral trickling and/or slipping of the process powder 22, in particular during the displacement of the powder compartment 28.

As shown, the powder compartment 28 also has a single end-face compartment section 54, which is formed perpendicular to the compartment displacement axis 52. The end-face compartment section 54 is designed to support the process powder column 27 along the compartment displacement axis 52, or counter to the direction of movement 46, in order to prevent process powder 22 from trickling and/or slipping counter to the direction of movement 46. According to the embodiment shown, the powder compartment 28 does not have an end-face compartment section 54 in the direction of movement 46. Process powder 22 trickling down in the direction of movement 46 can be picked up by the movement of the powder compartment 28 in the direction of movement 46 and thus does not reach the manufacturing-relevant areas of the additive manufacturing device 14.

As shown, the powder compartment 28 is arranged in the holding position 30 in front of the decoupling ramp 48. In other words, the powder compartment 28 can be arranged adjacent to the decoupling ramp 48 within the additive manufacturing device 14.

The additive manufacturing device 14 also has the coater unit 25 for filling the manufacturing cylinder 16. For this purpose, the coater unit 25 can be moved along a coater movement axis 56 via the manufacturing cylinder 16. According to the embodiment shown, the coater movement axis 56 is parallel, in particular congruent, to the compartment displacement axis 52.

The coater unit 25 is designed for coupling to the powder compartment 28. For this purpose, the coater unit 25 has at least one coupling plate 58, in this case two coupling plates 58, which are arranged or formed on the coater unit 25. Each coupling plate 58 has at least one pulling hook 60, which is designed to transmit a pulling movement of the coater unit 25 to the powder compartment 28. In addition, as shown, each coupling plate 58 has at least one slide plunger 62, which is designed to transmit a sliding movement of the coater unit 25 to the powder compartment 28. Furthermore, according to the embodiment shown, each coupling plate 58 has at least one spacer 64, which is designed to be arranged on the manufacturing plate 17 and ensures a predetermined distance between the manufacturing plate 17 and the compartment wall 42. For reasons of clarity, only a pulling hook 60, a slide plunger 62 and a spacer 64 are provided with a reference symbol.

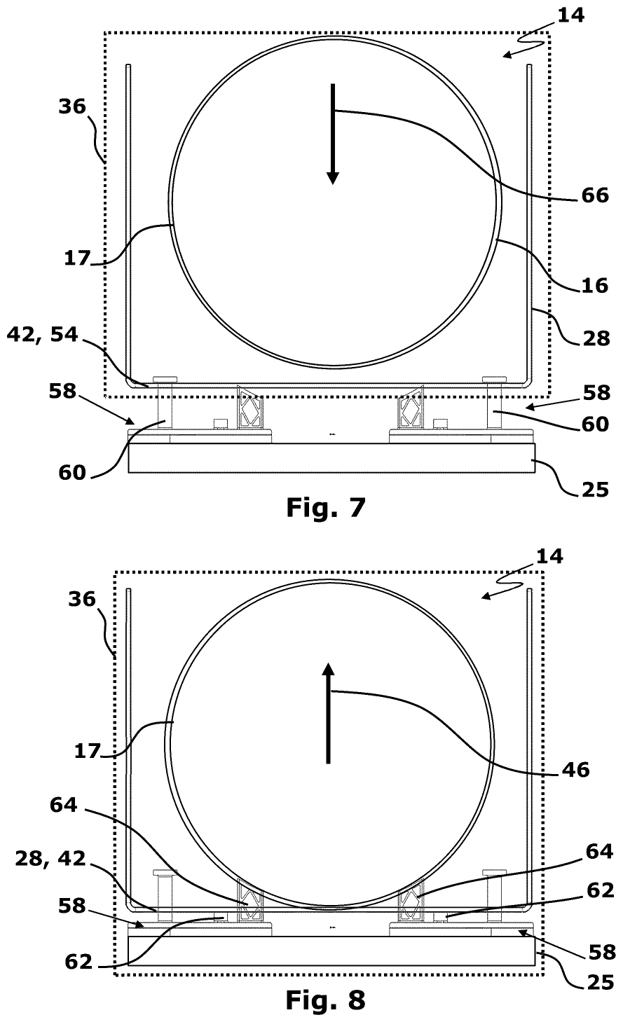

FIG. 7 shows the additive manufacturing device 14 from FIG. 6 in a detailed view of the receiving area 36. The coater unit 25 is arranged or coupled to the powder compartment 28. The pulling hooks 60 of the coupling plates 58 engage behind the compartment wall 42 of the powder compartment 28, which causes the powder compartment 28 to be moved, in this case pulled, in a direction of pull 66 by the coater unit 25. The compartment wall 42, or the end-face compartment section 54, typically has pulling recesses 68 (see FIG. 11) to accommodate the pulling hooks 60.

FIG. 8 shows the additive manufacturing device 14 from FIGS. 6 and 7 in a detailed view of the receiving area 36. The coater unit 25 is arranged on the powder compartment 28 as shown in FIG. 8, with the slide plungers 62 of the coupling plate 58 arranged or resting against the compartment wall 42 of the powder compartment 28. This can cause the powder compartment 28 to move or be pushed in the direction of movement 46 by the coater unit 25.

In addition, as shown, the spacers 64 of the coupling plates 58 are arranged on the manufacturing plate 17. The spacers 64 form a predetermined spacing from the slide plungers 62 in the direction of movement 46. This allows the manufacturing plate 17 to be moved, in this case pushed, together with the powder compartment 28 while maintaining a distance from the compartment wall 42.

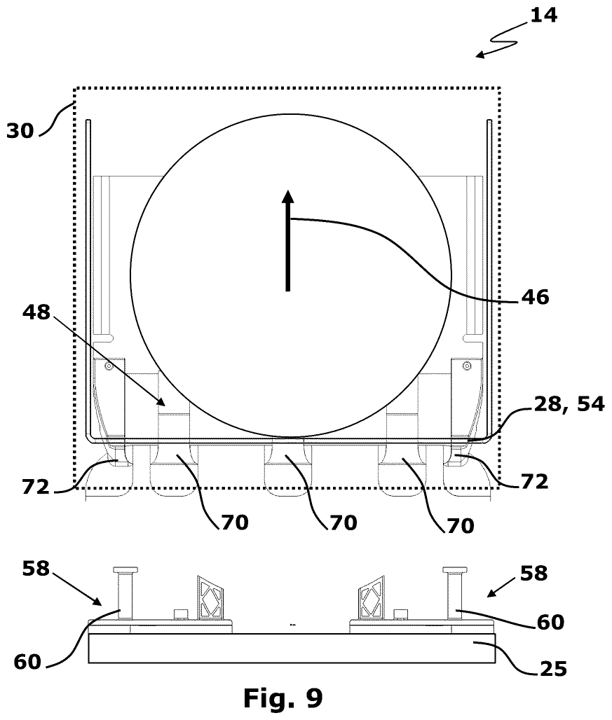

FIG. 9 shows the additive manufacturing device 14 from FIGS. 6 to 8 according to a state in which the powder compartment 28 is moved into the holding position 30 by the coater unit 25. As shown, the coater unit 25 is decoupled from the powder compartment 28.

The powder compartment 28 has the process powder column 27 (see FIGS. 2 to 5) and the manufacturing plate 17 and is arranged in the holding position 30 at or on the decoupling ramp 48.

As shown, the decoupling ramp 48 has three plate ramps 70, which are designed to raise the manufacturing plate 17 relative to the working plane 18 in the vertical direction 38 (see FIG. 3). Furthermore, the decoupling ramp 48 has two compartment ramps 72, which are designed to lift the powder compartment 28 or the end-face compartment section 54 relative to the working plane 18 in the vertical direction 38.

By moving the powder compartment 28 in the direction of movement 46, in this case by pushing it by means of the coater unit 25, the powder compartment 28 can be displaced in the vertical direction 38 relative to the coupling plates 58. This enables the pulling hooks 60 to be unhooked from the compartment wall 42, whereby the coater unit 25 is separated from the powder compartment 28 with a movement in the opposite direction to the direction of movement 46. In other words, by using the decoupling ramp 48, the powder compartment 28 can be automatically decoupled from the coater unit 25 by simple technical means.

The compartment ramps 72 are preferably steeper and/or higher than the plate ramps 70, as a result of which essentially only the powder compartment 28 or the end-face compartment section 52 has to be raised. This reduces the force to be applied by the coater unit 25. In contrast, the manufacturing plate 17 (see FIG. 8) can be pushed particularly evenly over the plate ramps 70.

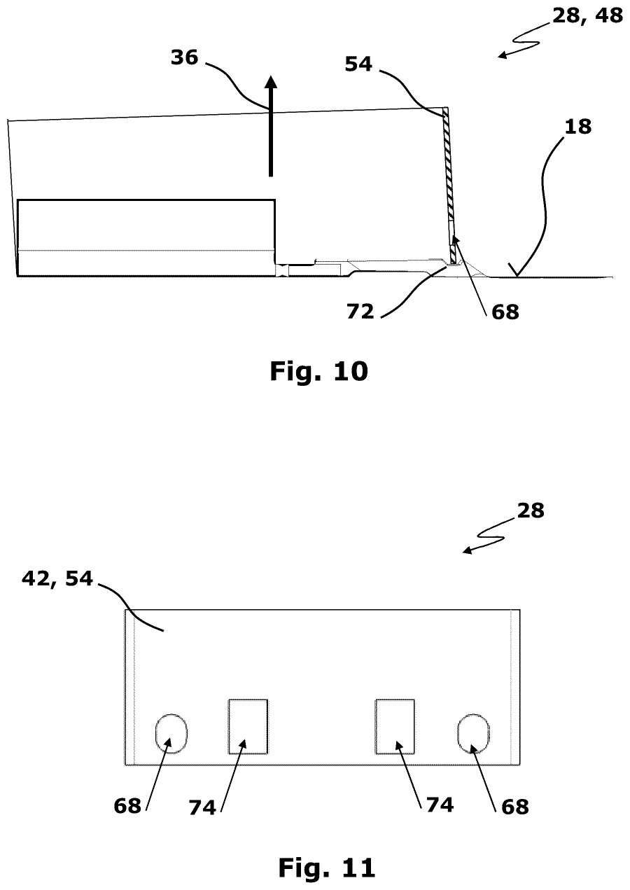

FIG. 10 shows a side view of the decoupling ramp 48 with the powder compartment 28 arranged thereon. For illustrative purposes, the powder compartment 28 is shown in section.

The powder compartment 28 is arranged on the compartment ramp 72 or the compartment ramps 72 of the decoupling ramp 48. In other words, the powder compartment 28 is in a raised position relative to the working plane 18 in the vertical direction 36. As a result, the pulling recesses 68 are positioned opposite the pulling hooks 60 (see FIGS. 6 to 9) are displaced vertically, allowing the pulling hooks 60 to be pulled out in the opposite direction to the direction of movement 46. As shown, the powder compartment 28 can be arranged in a recess, in particular a groove-like recess, on the upper side of the compartment ramp(s) 72, so that it is immovable, i.e., secured, in the opposite direction to the direction of movement 46 (see FIG. 9).

FIG. 11 shows the powder compartment 28 in a view of the end-face compartment section 54 of the compartment wall 42. In addition to the pulling recesses 68, the end-face compartment wall 42 has two penetration recesses 74, which are designed to reach through the spacers 64 (see FIGS. 6 to 9).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Preparation method 10;
Manufacturing order 12;
Manufacturing device 14;
Process chamber 15;
Manufacturing cylinder 16;
Manufacturing plate 17;
Working plane 18;
Powder trough 20;
Process powder 22;
Laser beam unit 24;
Coater unit 25;
Method step 26;
Process powder column 27;
Powder compartment 28;
Holding position 30;
Direction of movement 32;
Method step 34;
Receiving position 36;
Method step 40;
Compartment wall 42;
Method step 44;
Direction of movement 46;
Decoupling ramp 48;
Lateral compartment section 50;
Compartment displacement axis 52;
End-face compartment section 54;
Coater movement axis 56;
Coupling plate 58;
Pulling hook 60;
Slide plunger 62;
Spacer 64;
Direction of pull 66;
Pulling recess 68;
Plate ramp 70;
Compartment ramp 72;
Penetration recess 74.

1. An additive manufacturing device for series manufacturing of at least two manufacturing orders using a manufacturing cylinder of the additive manufacturing device, comprising:
at least one powder compartment that is movably arranged within a process chamber of the additive manufacturing device,
wherein the additive manufacturing device is configured to move the at least one powder compartment within the process chamber,
wherein the at least one powder compartment is configured to at least partially receive a process powder column formed from a process powder in the manufacturing cylinder, and
wherein the additive manufacturing device is configured to move the at least one powder compartment and the process powder column accommodated in the at least one powder compartment.

2. The additive manufacturing device according to claim 1, wherein the additive manufacturing device comprises a coater unit for filling the manufacturing cylinder with the process powder by moving the coater unit along a coater movement axis, and wherein the at least one powder compartment is configured to be movable along the coater movement axis by the coater unit.

3. The additive manufacturing device according to claim 2, wherein the coater unit is configured to push the at least one powder compartment.

4. The additive manufacturing device according to claim 2, wherein the coater unit is configured to pull the at least one powder compartment.

5. The additive manufacturing device according to claim 1, wherein the at least one powder compartment comprises at least one end-face compartment section, wherein the end-face compartment section is formed obliquely or perpendicularly to a compartment displacement axis, and wherein the end-face compartment section is formed for supporting the process powder column along the compartment displacement axis.

6. The additive manufacturing device according to claim 2, wherein the at least one powder compartment is configured for temporary arrangement on the coater unit.

7. The additive manufacturing device according to claim 1, wherein the at least one powder compartment is configured to receive a manufacturing plate carrying the process powder column, and wherein the additive manufacturing device is configured to displace the at least one powder compartment together with the manufacturing plate accommodated in the at least one powder compartment.

8. The additive manufacturing device according to claim 7, wherein the additive manufacturing device comprises a spacer, wherein the spacer is adapted for arrangement on the manufacturing plate in order to effect a minimum distance between the at least one powder compartment and the process powder column.

9. A preparation method for series manufacturing of at least two manufacturing orders while maintaining a protective gas atmosphere in an additive manufacturing device with a manufacturing cylinder and a powder compartment, comprising the method steps of:
producing a first manufacturing order in the manufacturing cylinder;
moving the powder compartment from a holding position to a receiving position above the manufacturing cylinder;
holding a process powder column of the manufacturing cylinder in the powder compartment by lifting a manufacturing plate of the manufacturing cylinder;
moving the powder compartment from the receiving position to the holding position; and
producing a second manufacturing order in the manufacturing cylinder.

10. The preparation method according to claim 9, wherein the additive manufacturing device comprises:
the powder compartment that is movably arranged within the process chamber of the additive manufacturing device,
wherein the additive manufacturing device is configured to move the powder compartment within the process chamber,
wherein the powder compartment is configured to at least partially receive the process powder column formed from a process powder in the manufacturing cylinder, and
wherein the additive manufacturing device is configured to move the powder compartment and the process powder column accommodated in the powder compartment.

11. The preparation method according to claim 9, wherein the additive manufacturing device comprises a coater unit for filling the manufacturing cylinder with a process powder, and wherein the powder compartment is moved from the receiving position into the holding position by the coater unit.

12. The preparation method according to claim 11, wherein the powder compartment is moved by being pushed from the receiving position into the holding position by the coater unit.

13. The preparation method according to claim 11, wherein the powder compartment is coupled to the coater unit and is moved from the holding position into the receiving position by the coater unit.

14. The preparation method according to claim 13, wherein the powder compartment is moved by being pulled from the holding position into the receiving position by the coater unit.

15. The preparation method according to claim 9, wherein the powder compartment remains in the holding position during the manufacturing of the first manufacturing order.
